(19) United States
(12) Patent Application Publication
(10) Pub. No.: US 2021/0104009 A1
(43) Pub. Date: Apr. 8, 2021

(54) MULTI-SAMPLE INSTRUCTIONS FOR DISTRIBUTION OF IMAGE PROCESSING WORKLOAD BETWEEN TEXTURE AND SHARED PROCESSORS

(71) Applicant: QUALCOMM Incorporated, San Diego, CA (US)

(72) Inventors: Liang Li, San Diego, CA (US); Andrew Evan Gruber, Arlington, MA (US)

(21) Appl. No.: 16/591,528

(22) Filed: Oct. 2, 2019

(51) Int. Cl. G06T 1/20; G06T 1/60; G06T 15/00

(52) U.S. Cl. CPC G06T 1/20; G06T 15/005; G06T 1/60

(57) ABSTRACT

Methods, systems, and devices for image processing are described. A device may identify a target pixel having a texel coordinate in an image. The device may select, based on the texel coordinate, a first texel sample of a first set of texel samples and a second texel sample of a second set of texel samples. In some examples, the device may group the first texel sample and the second texel sample into a third set of texel samples. The device may generate an instruction including the third set of texel samples and a weighted sum associated with the first texel sample and the second texel sample, and process the third set of texel samples based on the instruction. In some examples, the instruction may be a macro instruction.

### FIELD OF TECHNOLOGY

The following relates generally to image processing and more specifically to multi-sample instructions for distribution of image processing workload between texture and shared processors.

### BACKGROUND

A device may support image processing methods to perform operations on an image to enhance the image or extract image information (e.g., pixel information, texel information) from the image. For example, the device may include a graphics processing unit (GPU) which may support multi-dimensional graphics applications supportive of image shading. An example image processing shader may perform a filtering operation (e.g., a bilinear operation) on neighborhood texels associated with a target pixel in an image, using processes such as Gaussian de-noising to reduce processing overhead. Conventional approaches, however, may result in a high workload on the GPU due to the number of samples and the number of passes for processing each sample.

### SUMMARY

The described techniques relate to improved methods, systems, devices, and apparatuses that support multi-sample instructions for distribution of image processing workload between texture and shared processors. As such, the described techniques may be used to configure a device to support packing multiple samples of an image into an instruction and processing the image based on the instruction. In some examples, the instruction may be a macro instruction including weighted sums associated with the samples. The described techniques may be used to configure the device to process the macro instruction using a texture engine. In some examples, the device may determine multiple samples from texture data of an image and combine the samples into a packed set of samples. In some examples, the device may generate a macro instruction including a packed set of samples and weighted sums associated with the samples. As a result, the device may process the image (e.g., the samples) based on the macro instruction, improving throughput and processing efficiency.

Additionally, in some examples, processing the macro instruction using the texture engine may include utilizing a texture arithmetic logic unit (ALU) associated with the texture engine or accumulations (e.g., accumulation texture objects) within the texture engine. In some examples, the described techniques may be used to configure the device to utilize filtering operations configured within the texture engine, such as filtering operations for enhancing image quality of textures on surfaces (e.g., anisotropic filtering). In some examples, the device may process neighboring samples of a target pixel jointly. According to some examples, where a large number neighborhood samples (e.g., samples of neighboring texels of a target pixel), the device may combine the samples for processing in an existing hardware pipeline, and may improve hardware throughput at no extra cost (e.g., no added hardware resources).

A method of image processing at a device is described. The method may include identifying a target pixel having a texel coordinate in an image, selecting, based on the texel coordinate, a first texel sample of a first set of texel samples and a second texel sample of a second set of texel samples, grouping the first texel sample and the second texel sample into a third set of texel samples, generating an instruction including the third set of texel samples and a weighted sum associated with the first texel sample and the second texel sample, and processing the third set of texel samples based on the instruction.

An apparatus for image processing is described. The apparatus may include a processor, memory coupled with the processor, and instructions stored in the memory. The instructions may be executable by the processor to cause the apparatus to identify a target pixel having a texel coordinate in an image, select, based on the texel coordinate, a first texel sample of a first set of texel samples and a second texel sample of a second set of texel samples, group the first texel sample and the second texel sample into a third set of texel samples, generate an instruction including the third set of texel samples and a weighted sum associated with the first texel sample and the second texel sample, and process the third set of texel samples based on the instruction.

Another apparatus for image processing is described. The apparatus may include means for identifying a target pixel having a texel coordinate in an image, selecting, based on the texel coordinate, a first texel sample of a first set of texel samples and a second texel sample of a second set of texel samples, grouping the first texel sample and the second texel sample into a third set of texel samples, generating an instruction including the third set of texel samples and a weighted sum associated with the first texel sample and the second texel sample, and processing the third set of texel samples based on the instruction.

A non-transitory computer-readable medium storing code for image processing at a device is described. The code may include instructions executable by a processor to identify a target pixel having a texel coordinate in an image, select, based on the texel coordinate, a first texel sample of a first set of texel samples and a second texel sample of a second set of texel samples, group the first texel sample and the second texel sample into a third set of texel samples, generate an instruction including the third set of texel samples and a weighted sum associated with the first texel sample and the second texel sample, and process the third set of texel samples based on the instruction.

Some examples of the method, apparatuses, and non-transitory computer-readable medium described herein may further include operations, features, means, or instructions for determining a set of neighboring texels associated with the target pixel based on the texel coordinate, where selecting the first texel sample of the first set of texel samples and the second texel sample of the second set of texel samples may be based on the set of neighboring texels.

In some examples of the method, apparatuses, and non-transitory computer-readable medium described herein, one or more of the first texel sample or the second texel sample correspond to the set of neighboring texels.

In some examples of the method, apparatuses, and non-transitory computer-readable medium described herein, selecting the first texel sample of the first set of texel samples and the second texel sample of the second set of texel samples may include operations, features, means, or instructions for selecting the first texel sample in a first direction with respect to the target pixel in the image, and selecting the second texel sample in a second direction with respect to the target pixel in the image.

In some examples of the method, apparatuses, and non-transitory computer-readable medium described herein, the second direction may be different from the first direction.

In some examples of the method, apparatuses, and non-transitory computer-readable medium described herein, one or more of the first direction or the second direction includes a positive vertical direction with respect to the target pixel, a negative vertical direction with respect to the target pixel, a positive horizontal direction with respect to the target pixel, or a negative horizontal direction with respect to the target pixel.

Some examples of the method, apparatuses, and non-transitory computer-readable medium described herein may further include operations, features, means, or instructions for selecting the first texel sample of the first set of texel samples and the second texel sample of the second set of texel samples may be based on a distance between the texel coordinate of the target pixel and one or more of a texel coordinate of the first texel sample or a texel coordinate of the second texel sample.

Some examples of the method, apparatuses, and non-transitory computer-readable medium described herein may further include operations, features, means, or instructions for storing the third set of texel samples in a cache memory of the device based on the grouping.

In some examples of the method, apparatuses, and non-transitory computer-readable medium described herein, storing the third set of texel samples in the cache memory may include operations, features, means, or instructions for storing texel samples of the third set of texel samples in adjacent memory blocks in the cache memory.

In some examples of the method, apparatuses, and non-transitory computer-readable medium described herein, storing the third set of texel samples in the cache memory may include operations, features, means, or instructions for storing texel samples of the third set of texel samples in one or more memory blocks in the cache memory based on one or more previous memory paths.

In some examples of the method, apparatuses, and non-transitory computer-readable medium described herein, processing the third set of texel samples may include operations, features, means, or instructions for processing the first texel sample and the second texel sample in a single processing cycle.

In some examples of the method, apparatuses, and non-transitory computer-readable medium described herein, the instruction includes a macro instruction.

Some examples of the method, apparatuses, and non-transitory computer-readable medium described herein may further include operations, features, means, or instructions for determining a first weight associated with the first texel sample and a second weight with the second texel sample based on a distance between the texel coordinate of the target pixel and one or more of a texel coordinate of the first texel sample or a texel coordinate of the second texel sample, and determining the weighted sum based on one or more of the first weight or the second weight.

In some examples, a device 105 may identify a target pixel having a texel coordinate in an image. The device 105 may select, based on the texel coordinate, a first texel sample of a first set of texel samples and a second texel sample of a second set of texel samples. In some aspects, the device 105 may group the first texel sample and the second texel sample into a third set of texel samples. The device 105 may generate an instruction (e.g., a macro instruction) including the third set of texel samples and a weighted sum associated with the first texel sample and the second texel sample, and process the third set of texel samples based on the instruction.

### BRIEF DESCRIPTION OF THE DRAWINGS

FIG. 1 illustrates a multimedia system for a device that supports multi-sample instructions for distribution of image processing workload between texture and shared processors in accordance with aspects of the present disclosure.

FIGS. 2A and 2B illustrate examples of images which may be processed using post processing in accordance with aspects of the present disclosure.

FIG. 3 illustrates an example diagram of an image processing scheme for post processing of images that supports multi-sample instructions for distribution of image processing workload between texture and shared processors in accordance with aspects of the present disclosure.

FIGS. 4A and 4B illustrate example diagrams for multi-sample instructions for distribution of image processing workload between texture and shared processors in accordance with aspects of the present disclosure.

FIGS. 5A and 5B illustrate example diagrams for multi-sample instructions for distribution of image processing workload between texture and shared processors in accordance with aspects of the present disclosure.

FIGS. 6A through 6C illustrate example diagrams for multi-sample instructions for distribution of image processing workload between texture and shared processors in accordance with aspects of the present disclosure.

FIG. 7 shows a block diagram of devices that support multi-sample instructions for distribution of image processing workload between texture and shared processors in accordance with aspects of the present disclosure.

FIG. 8 shows a block diagram of a multimedia manager that supports multi-sample instructions for distribution of image processing workload between texture and shared processors in accordance with aspects of the present disclosure.

FIG. 9 shows a diagram of a system including a device that supports multi-sample instructions for distribution of image processing workload between texture and shared processors in accordance with aspects of the present disclosure.

FIGS. 10 through 12 show flowcharts illustrating methods that support multi-sample instructions for distribution of image processing workload between texture and shared processors in accordance with aspects of the present disclosure.

### DETAILED DESCRIPTION

A device may support image processing methods to perform operations on an image for enhancing the image or extracting image information (e.g., pixel information) from the image. For example, a graphics processing unit (GPU) may support multi-dimensional graphics applications supportive of post processing operations such as image shading. An example image processing shader may perform a filtering operation (e.g., a bilinear operation) on neighborhood texels associated with a target pixel in an image, using processes such as Gaussian de-noising to reduce processing overhead. In some examples, the device may use multiple sample instructions and multiple operations per sample, which may result in a high workload on the GPU due to the number of samples and the number of passes for processing each sample. In some examples, an image processing shader may support using a weighted sum of multiple samples of an image.

The device may, in some examples, support packing multiple samples of an image into a macro instruction and processing an image based on the macro instruction. In some examples, the macro instruction may include weight sums associated with the samples. The device may process the macro instruction using a texture engine, which may reduce a number of shader instructions, a number of data paths, a number of memory accesses, and load on general purpose registers (GPRs), as well as improve cache locality. In some examples, a device may determine multiple samples from texture data of an image and combine the samples into a packed set of samples. For example, the device may generate a macro instruction including the packed set of samples and weight sums associated with the samples. As a result, the device may process the image (e.g., the samples) based on the macro instruction, improving throughput and processing efficiency.

Aspects of the disclosure are initially described in the context of wireless communications systems. Aspects of the disclosure are further illustrated by and described with reference to apparatus diagrams, system diagrams, and flowcharts that relate to multi-sample instructions for distribution of image processing workload between texture and shared processors.

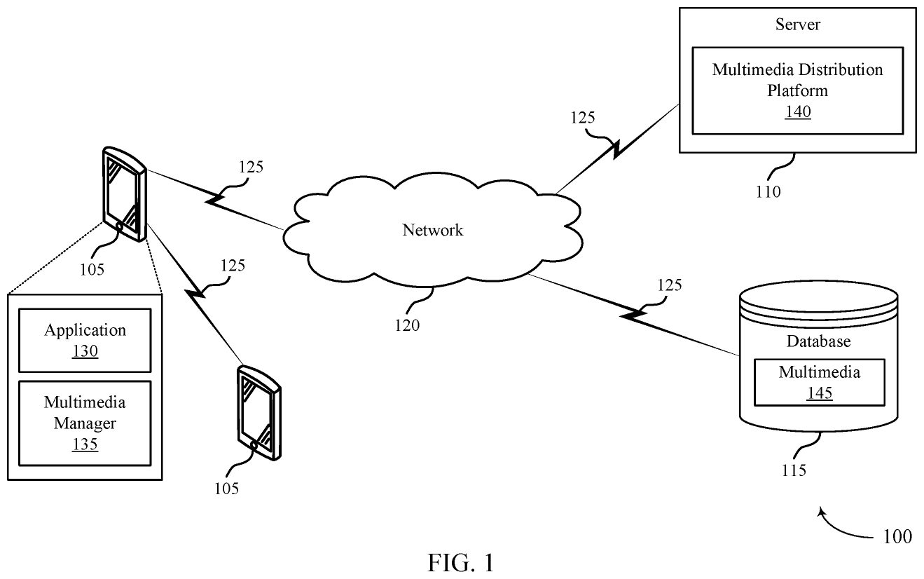

FIG. 1 illustrates a multimedia system 100 for a device that supports multi-sample instructions for distribution of image processing workload between texture and shared processors in accordance with aspects of the present disclosure. The multimedia system 100 may include devices 105, a server 110, and a database 115. Although, the multimedia system 100 illustrates two devices 105, a single server 110, a single database 115, and a single network 120, the present disclosure applies to any multimedia system architecture having one or more devices 105, servers 110, databases 115, and networks 120. The devices 105, the server 110, and the database 115 may communicate with each other and exchange information that supports multi-sample instructions for distribution of image processing workload between texture and shared processors, such as multimedia packets, multimedia data, or multimedia control information, via network 120 using communications links 125. In some cases, a portion or all of the techniques described herein supporting multi-sample instructions for distribution of image processing workload between texture and shared processors may be performed by the devices 105 or the server 110, or both.

A device 105 may be a cellular phone, a smartphone, a personal digital assistant (PDA), a wireless communication device, a handheld device, a tablet computer, a laptop computer, a cordless phone, a display device (e.g., monitors), or the like that supports various types of communication and functional features related to multimedia (e.g., transmitting, receiving, broadcasting, streaming, sinking, capturing, storing, and recording multimedia data). A device 105 may, additionally or alternatively, be referred to by those skilled in the art as a user equipment (UE), a user device, a smartphone, a Bluetooth device, a Wi-Fi device, a mobile station, a subscriber station, a mobile unit, a subscriber unit, a wireless unit, a remote unit, a mobile device, a wireless device, a wireless communications device, a remote device, an access terminal, a mobile terminal, a wireless terminal, a remote terminal, a handset, a user agent, a mobile client, a client, or some other suitable terminology. In some cases, the devices 105 may also be able to communicate directly with another device (e.g., using a peer-to-peer (P2P) or device-to-device (D2D) protocol). For example, a device 105 may be able to receive from or transmit to another device 105 variety of information, such as instructions or commands (e.g., multimedia-related information).

The devices 105 may include an application 130 and a multimedia manager 135. While, the multimedia system 100 illustrates the devices 105 including both the application 130 and the multimedia manager 135, the application 130 and the multimedia manager 135 may be an optional feature for the devices 105. In some cases, the application 130 may be a multimedia-based application that can receive (e.g., download, stream, broadcast) from the server 110, database 115 or another device 105, or transmit (e.g., upload) multimedia data to the server 110, the database 115, or to another device 105 via using communications links 125.

The multimedia manager 135 may be part of a general-purpose processor, a digital signal processor (DSP), an image signal processor (ISP), a central processing unit (CPU), a graphics processing unit (GPU), a microcontroller, an application-specific integrated circuit (ASIC), a field-programmable gate array (FPGA), a discrete gate or transistor logic component, a discrete hardware component, or any combination thereof, or other programmable logic device, discrete gate or transistor logic, discrete hardware components, or any combination thereof designed to perform the functions described in the present disclosure, or the like. For example, the multimedia manager 135 may process multimedia (e.g., image data, video data, audio data) from or write multimedia data to a local memory of the device 105 or to the database 115.

The multimedia manager 135 may also be configured to provide multimedia enhancements, multimedia restoration, multimedia analysis, multimedia compression, multimedia streaming, and multimedia synthesis, among other functionality. For example, the multimedia manager 135 may perform white balancing, cropping, scaling (e.g., multimedia compression), adjusting a resolution, multimedia stitching, color processing, multimedia filtering, spatial multimedia filtering, artifact removal, frame rate adjustments, multimedia encoding, multimedia decoding, and multimedia filtering. By further example, the multimedia manager 135 may process multimedia data to support multi-sample instructions for distribution of image processing workload between texture and shared processors, according to the techniques described herein.

The multimedia manager 135 may identify a target pixel having a texel coordinate in an image. In some examples, the multimedia manager 135 may select, based on the texel coordinate, a first texel sample of a first set of texel samples and a second texel sample of a second set of texel samples. In an example, the multimedia manager 135 may group the first texel sample and the second texel sample into a third set of texel samples. The multimedia manager 135 may generate an instruction including the third set of texel samples and a weighted sum associated with the first texel sample and the second texel sample. In some examples, the multimedia manager 135 may process the third set of texel samples based on the instruction. The multimedia manager 135 may be an example of aspects of the multimedia manager 945 described herein.

The server 110 may be a data server, a cloud server, a server associated with a multimedia subscription provider, proxy server, web server, application server, communications server, home server, mobile server, or any combination thereof. The server 110 may in some cases include a multimedia distribution platform 140. The multimedia distribution platform 140 may allow the devices 105 to discover, browse, share, and download multimedia via network 120 using communications links 125, and therefore provide a digital distribution of the multimedia from the multimedia distribution platform 140. As such, a digital distribution may be a form of delivering media content such as audio, video, images, without the use of physical media but over online delivery mediums, such as the Internet. For example, the devices 105 may upload or download multimedia-related applications for streaming, downloading, uploading, processing, enhancing, etc. multimedia (e.g., images, audio, video). The server 110 may also transmit to the devices 105 a variety of information, such as instructions or commands (e.g., multimedia-related information) to download multimedia-related applications on the device 105.

The database 115 may store a variety of information, such as instructions or commands (e.g., multimedia-related information). For example, the database 115 may store multimedia 145. The device may support multi-sample instructions for distribution of image processing workload between texture and shared processors associated with the multimedia 145. The device 105 may retrieve the stored data from the database 115 via the network 120 using communication links 125. In some examples, the database 115 may be a relational database (e.g., a relational database management system (RDBMS) or a Structured Query Language (SQL) database), a non-relational database, a network database, an object-oriented database, or other type of database, that stores the variety of information, such as instructions or commands (e.g., multimedia-related information).

The network 120 may provide encryption, access authorization, tracking, Internet Protocol (IP) connectivity, and other access, computation, modification, or functions. Examples of network 120 may include any combination of cloud networks, local area networks (LAN), wide area networks (WAN), virtual private networks (VPN), wireless networks (using 802.11, for example), cellular networks (using third generation (3G), fourth generation (4G), long-term evolved (LTE), or new radio (NR) systems (e.g., fifth generation (5G)), etc. Network 120 may include the Internet.

The communications links 125 shown in the multimedia system 100 may include uplink transmissions from the device 105 to the server 110 and the database 115, or downlink transmissions, from the server 110 and the database 115 to the device 105. The wireless links 125 may transmit bidirectional communications or unidirectional communications. In some examples, the communication links 125 may be a wired connection or a wireless connection, or both. For example, the communications links 125 may include one or more connections, including but not limited to, Wi-Fi, Bluetooth, Bluetooth low-energy (BLE), cellular, Z-WAVE, 802.11, peer-to-peer, LAN, wireless local area network (WLAN), Ethernet, FireWire, fiber optic, or other connection types related to wireless communication systems.

The multimedia system 100 may provide improvements in image processing, for example, distributing image processing workload between texture and shared processors. In one example, the multimedia system 100 may reduce the number of instances (e.g., a number of samples) for image processing by using packed samples, which may reduce the number of associated processing operations, resulting in power savings and reduced processor overhead for the devices 105 . In another example, processing using packed samples may improve cache locality and memory access associated with accessing stored sample data for the devices 105. Furthermore, the multimedia system 100 may provide benefits and enhancements to the operation of the devices 105. For example, by consolidating access to a cache location common to multiple samples, for example, through the use of packed samples, the operational characteristics, such as power consumption, processor utilization (e.g., DSP, CPU, GPU, ISP processing utilization), and memory usage of the devices 105 may be reduced. The multimedia system 100 may also provide processing and memory efficiency to the devices 105 by reducing latency associated with processes related to multi-sample instructions for distribution of image processing workload between texture and shared processors.

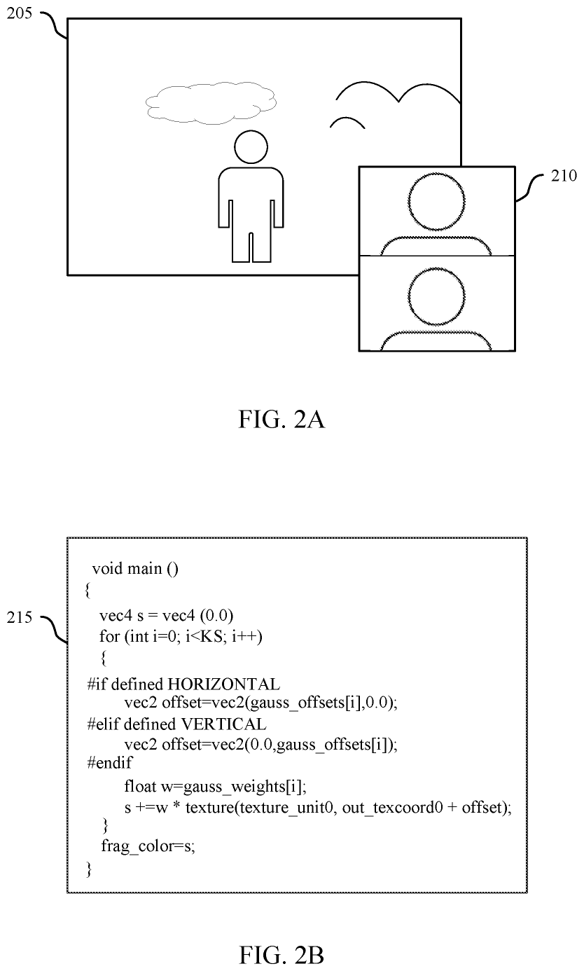

FIGS. 2A and 2B illustrate an example image which may be processed using post processing in accordance with aspects of the present disclosure. Referring to FIG. 2A, image 205 may be an image captured using image sensors of a device (e.g., a device 105 as described with reference to FIG. 1). The image 205 may include multiple texels 210. Referring to FIG. 2B, code 215 illustrates an example code or instructions for post processing the image 205 (e.g., using Gaussian blurring). Some approaches for post processing images, for example, the image 205 may include processing target pixels in the image 205 using image processing shaders. In some image processing shaders, filtering operations may include texture filtering for texture data, such as bilinear texture filtering for obtaining constant texture data with respect to the target pixels. In some examples, processing may include determining neighboring texels with respect to the target pixels of the image 205, and performing a bilinear filtering operation on the neighborhood texels.

Gaussian blurring (e.g., Gaussian smoothing) may use a two-pass algorithm. The algorithm may utilize multiple (e.g., two) sample instructions and multiple (e.g., two) multiply-accumulate operations per sample (e.g., texel sample). In digital signal processing (e.g., image processing), multiply-accumulate operations may compute the product of two numbers and sum the product to an accumulator. In some examples, use of Gaussian blurring and a two-pass algorithm may result in a high workload on a GPU due to the number of samples, the number of passes for processing each sample, and the number of operations in each pass (e.g., each pass may include ten (10) or more bilinear filtering operations). Additionally, Gaussian blurring may be heavily bound by texels (e.g., target pixels, neighbor texels) in the image 205. For example, processing of the image 205 by Gaussian blurring may be affected by the number of sampled texels in a current pixel neighborhood area (e.g., sampled texels neighboring a target pixel) and weighted accumulations associated with the sampled texels.

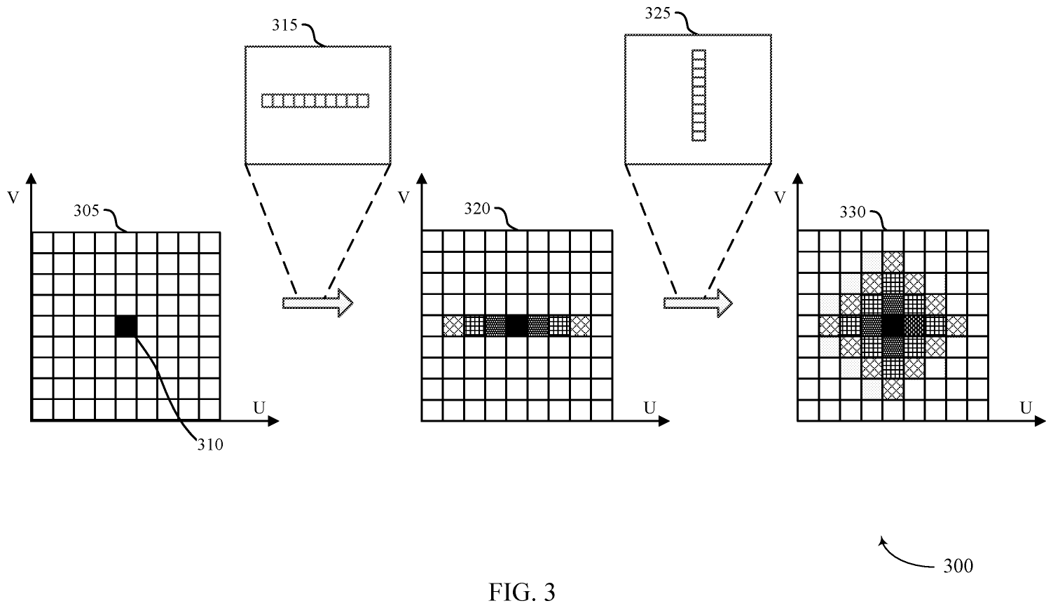

FIG. 3 illustrates an example diagram of an image processing scheme 300 for post processing of images that supports multi-sample instructions for distribution of image processing workload between texture and shared processors in accordance with aspects of the present disclosure. In some examples, texture filtering described herein may be implemented by aspects of the multimedia system 100. According to example aspects described herein, a device supporting a multi-dimensional graphics application (e.g., 2D, 3D) may include a GPU that may support texture sampling relating to multi-dimensional graphics. For example, the GPU may include texture sampling in a graphics pipeline where data may be read from an input texture image provided by the multi-dimensional graphics application. The device and GPU may be examples of aspects of the devices 105 and GPU, as described in FIG. 1.

An image 305 may be defined by a multi-dimensional function F(u,v), where u and v are spatial coordinates, and the amplitude F at any pair of coordinates (u,v) may be an intensity of the image 305 at a point corresponding to the coordinates (u,v). With reference to FIG. 1, the device 105 may identify a target pixel 310 (e.g., target texel) having a texel coordinate (u,v) in the image 305 (e.g., a texture coordinate in an input texture image provided by a graphics application). The image 305 may be, for example, a texture map or texture image including an array of texels having known texel values (e.g., color values, monochrome values). The image 305 may be, for example, a texture map (e.g., a UV texture map) or texture image. In some examples, the image 305 may be a multidimensional grid (e.g., a UV grid). According to aspects described herein, the letters “U” and “V” may denote the axes of the image 305. With reference to FIG. 1, the devices 105 may identify or select the target pixel 310 based on, for example, a portion of a scene or object (e.g., a target object) to be rendered by the graphics application. Alternatively or additionally, the devices 105 may identify or select the target pixel 310 on a random or semi-random basis.

Based on the texel coordinate (u,v) of the target pixel 310, the devices 105 may determine a set of neighboring texels included in the image 305. In an example, one or more of the neighboring texels may be adjacent (e.g., directly adjacent) to the texel coordinate (u,v) of the target pixel 310. For example, one or more of the neighboring texels may be in contact with the texel coordinate (u,v). According to example aspects herein, the target pixel 310 and one or more of the neighboring texels may be associated with the same scene or object (e.g., target object) in the image 305.

In some examples, the neighboring texels may be located immediately above, below, left, and right of the texel coordinate (u,v), respectively. In some examples, the neighboring texels may be located to the upper left, lower left, upper right, and lower right of the texel coordinate (u,v), respectively. The devices 105 may determine texel values (e.g., color values, monochrome values) of multiple neighboring texels of the set of neighboring texels and process the target pixel 310 based on the texel values. In an example, in processing the target pixel, the devices 105 may apply one or more filtering operations on the target pixel 310 using a filtering model. In some examples, the filtering operations may include texture filtering (e.g., linear texture filtering, bilinear texture filtering).

The devices 105 may, in some examples, process the target pixel 310 using linear texture filtering (e.g., using one or more of a linear texture filtering 315 or a linear texture filtering 325, for example, where the linear texture filtering 315 may generate an image 320), for example, based on the texel values (e.g., color values, monochrome values) of two or more neighboring texels of the set of neighboring texels. In some examples, in processing the target pixel 310, the devices 105 may determine the texel value (e.g., color value, monochrome value) for the target pixel 310 based on an interpolation operation using a weighted average of texel values (e.g., color values, monochrome values) of the two or more neighboring texels of the set of neighboring texels.

The devices 105 may process the target pixel 310 using bilinear texture filtering (e.g., using one or more of the linear texture filtering 315 or the linear texture filtering 325, for example, where the linear texture filtering 315 and the linear texture filtering 325 may generate the image 320), for example, based on the texel values (e.g., color values, monochrome values) of all neighboring texels of the set of neighboring texels. In some examples, in processing the target pixel 310, the devices 105 may determine the texel value (e.g., color value, monochrome value) for the target pixel 310 based on an interpolation operation using a weighted average of texel values (e.g., color values, monochrome values) of all neighboring texels of the set of neighboring texels. In some examples, the devices 105 may determine the weighted average based on one or more weighting coefficients applied to the texel values.

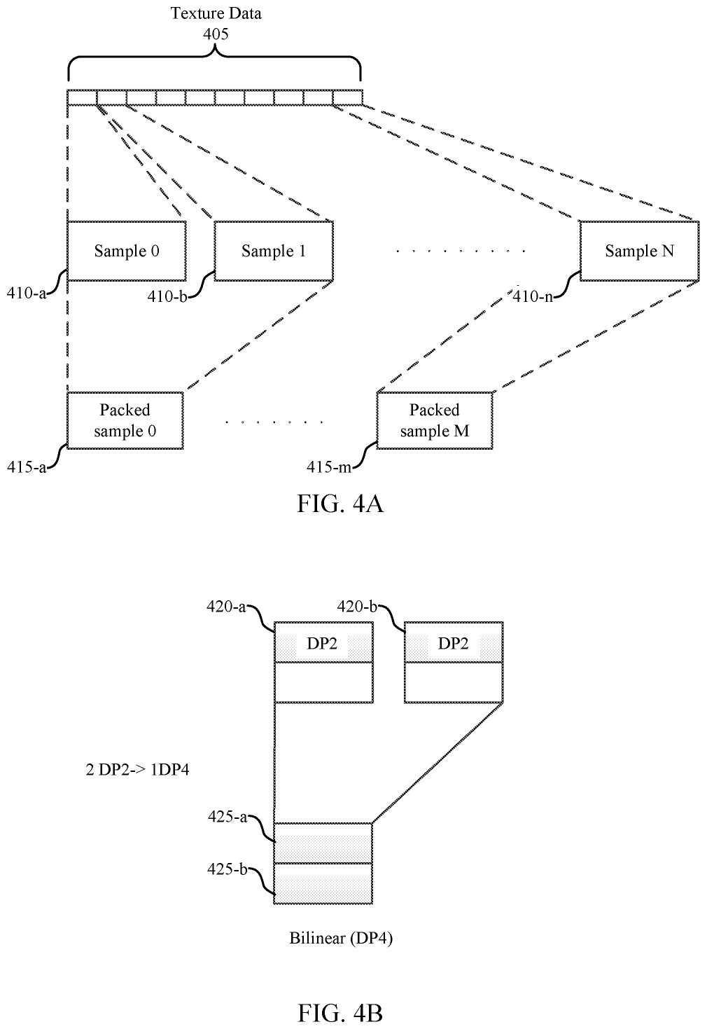

FIGS. 4A and 4B illustrate example diagrams for multi-sample instructions for distribution of image processing workload between texture and shared processors in accordance with aspects of the present disclosure. In some examples, the examples illustrated in FIGS. 4A and 4B may implement aspects of the multimedia system 100. Aspects of the examples illustrated in FIGS. 4A and 4B may implement aspects of the system 100, for example, by the devices 105. In some examples, aspects of the examples illustrated in FIGS. 4A and 4B may be implemented by a GPU of the devices 105.

According to examples of aspects illustrated in FIG. 4A (and with reference to FIG. 1), the devices 105 may identify a target pixel having a texel coordinate in an image. The devices 105 may determine (e.g., select) one or more samples 410-a through 410-n (e.g., samples 0 through sample N, where N may be an integer value) from texture data 405 of the image. The samples 410-a through 410-n may be, for example, texel samples as described herein. The devices 105 may pack multiple samples from among the samples 410-a through 410-n into one or more packed samples 415-a through 415-m (e.g., packed samples 0 through packed sample M, where M may be an integer value). For example, the devices 105 may execute an instruction (e.g., a macro instruction) to combine or “pack” the samples 410-a and 410-b (e.g., sample 0 and sample 1) into a packed sample 415-a (e.g., packed sample 0). In some examples, the devices 105 may execute an instruction (e.g., a macro instruction “sam-packed”) to combine or “pack” the sample 410-n (e.g., sample N) with one or more of other samples among samples 410 into a packed sample 415-m (e.g., packed sample M).

In some examples, based on the instruction (e.g., macro instruction), the devices 105 may combine or “pack” samples 410-a and 410-b (e.g., sample 0 and sample 1) into the packed sample 415-a (e.g., packed sample 0) based on one or more weighting coefficients. For example, the instruction may generate a “sam-packed” result=tex.sample0*c0+tex.sample1*c1, where tex.sample0 refers to the sample 410-a (e.g., sample 0), tex.sample1 refers to the sample 410-b (e.g., sample 1), and c0 and c1 are weighting coefficients respectively corresponding to tex.sample0 and tex.sample1.

In some examples, the devices 105 may generate the packed samples 415-a through 415-m based on a summation of weighted samples. For example, the devices 105 may generate weighted samples by multiplying texel values (e.g., color values, monochrome values) of the samples 410-a through 410-n by weighting coefficients respectively corresponding to the samples 410-a through 410-n, and may generate the packed samples 415-a through 415-m by summing weighted samples. In some examples, the devices 105 may sum the weighted samples by “packing” every two weighted samples into a packed sample (e.g., a packed sample instance). The weighting coefficients may be based on characteristics (e.g., texel coordinates, pixel coordinates) associated with each of the samples 410-a through 410-n. For example, the weighting coefficients may be based on a distance (e.g., in texel coordinates, pixel coordinates) from pixels (e.g., texels, texel coordinates) associated with the samples 410-a through 410-n to a target pixel (e.g., texel, texel coordinate).

Aspects of the examples described herein may improve on image processing operations implemented by some devices. For example, a Gaussian blur shader may determine samples for each pixel (e.g., texel) in an image, determine weighted samples for each pixel (e.g., texel) in the image (e.g., sample0*c0), and determine a weighted sum all the weighted samples (e.g., sample0*c0+sample1*c1+sample2*c2+ . . . sampleN*cN), in each dimension of the image. Accordingly, such image processing operations by some devices may use two sample instructions and two multiply-accumulate operations to complete image processing operations. The techniques described herein may provide advantages in image processing operations compared to approaches by some devices. In one example, by reducing the number of instances (e.g., samples) by using packed samples, the number of processing operations (e.g., operations associated with Gaussian process regression) may be reduced, which may result in power savings and reduced processor overhead at the devices 105. In another example, as will be further described herein, the example operations of generating packed samples may improve cache locality associated with accessing sample data (e.g., sample data associated with pixels or texels neighboring a target pixel or texel). In some examples, the devices 105, or a GPU or DSP within the devices 105, may consolidate access to a cache location common to multiple samples (e.g., may refer to the same location in a cache where the sample data is stored based on packed samples).

As illustrated in the example of FIG. 4B, the devices 105 may achieve higher performance levels (e.g., speed, efficiency, latency) when performing image processing operations based on packed samples, as the devices 105 may process the samples without true (e.g., full) bilinear filtering operations. For example, according to examples of aspects herein, the devices 105 may fully utilize bilinear operations, such that the devices 105 may complete (e.g., process) two DP2 samples in one processing cycle. For example, the devices 105 may complete (e.g., process) one DP4 per processing cycle, and the devices 105 may be able to complete (e.g., process) two packed DP2s in one processing cycle (e.g., as illustrated with packed sample 425-a and packed ample 425-b. As such, the devices 105 may achieve an end result (e.g., process an image) in a shorter amount of time (e.g., half the amount of cycles or samples) compared to two-pass algorithms which utilize multiple (e.g., two) sample instructions and multiple (e.g., two) multiply-accumulate operations per sample (e.g., as illustrated with DP2 sample 420-a and DP2 sample 420-b). For example, in a Gaussian two-pass algorithm, each pass sample may be generated using a one dimension filter (e.g., linear filter in a horizontal direction, linear filter in a vertical direction). In an example, where existing hardware in the devices 105 may be configured or designed to process a two-dimension sample obtained by a two-dimension filter (e.g., DP4, where a*w0+b*w1+c*w2+d*w3) in accordance with multiple processing cycles, the devices 105 according to the example aspects described herein may be configured to process two one-dimension samples (DP2, a*w0+b*w1) within a single processing cycle).

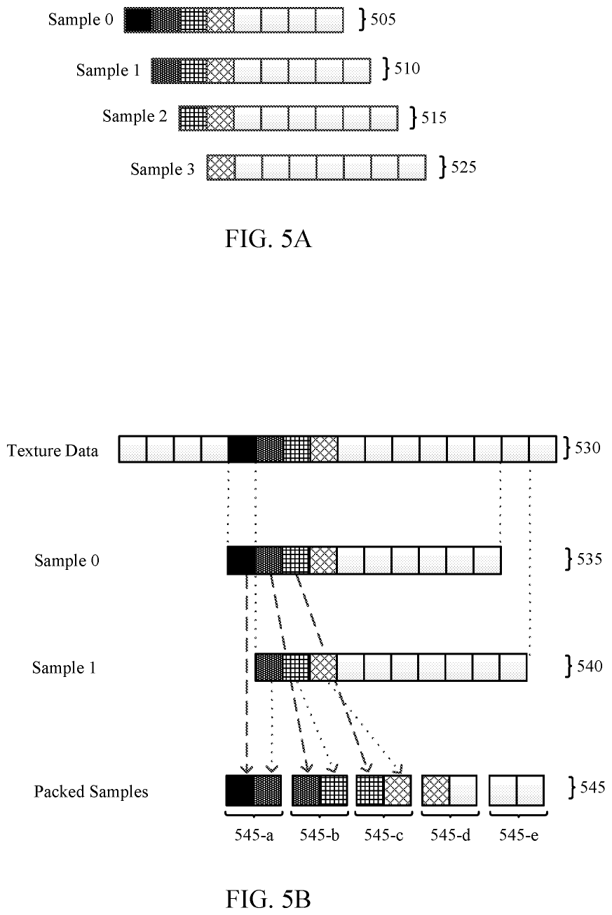

FIGS. 5A and 5B illustrate example diagrams for multi-sample instructions for distribution of image processing workload between texture and shared processors in accordance with aspects of the present disclosure. In some examples, the examples illustrated in FIGS. 5A and 5B may implement aspects of the multimedia system 100. In some examples, aspects of the examples illustrated in FIGS. 5A and 5B may be implemented by a GPU of the devices 105.

FIG. 5A illustrates an example of multiple samples 505 through 525 (e.g., sample 0 through sample 3) generated by the devices 105 for one processing cycle. The devices 105 may generate the samples from texture data (e.g., texture surface data) of an image. For example, the devices 105 may generate multiple samples from texture data of an image and fetch data from the samples, as described herein with respect to FIG. 5B.

In FIG. 5B, the devices 105 may access data from samples 535 and 540 (e.g., sample 0 and sample 1) determined from texture data 530 (e.g., texture surface data) of an image. For example, the devices 105 may access (e.g., fetch) data from the samples 535 and 540 (e.g., sample 0 and sample 1) and combine or add the data, creating packed samples 545. That is, the devices 105 may access (e.g., fetch) data from the samples 535 and 540 (e.g., sample 0 and sample 1) and combine or pack the data into multiple packed samples 545 (e.g., packed sample 545-a, packed sample 545-b, packed sample 545-c, etc.). According to examples of aspects herein, the devices 105 may extract data from samples in an order (e.g., an ascending order) starting from respective first sections of the samples to respective second sections of the samples, and so on. For example, the devices 105 may extract data from samples 535 and 540 (e.g., sample 0, sample 1) in ascending order starting from respective first sections of the samples 535 and 540 (e.g., starting at sample 0, section 0, followed by sample 1, section 0), followed by respective second sections of samples 535 and 540 (e.g., sample 0, section 1, followed by sample 1, section 1). The packed sample data fetch sequence may be, for example, sample0.section0, sample1.section0, sample0.section1, sample1.section1, etc.

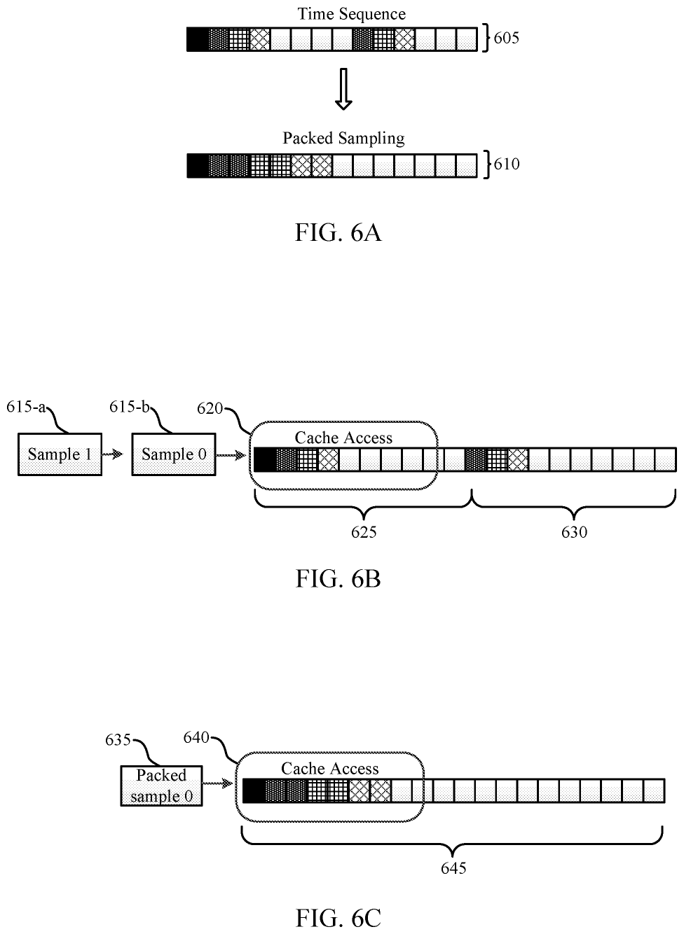

FIG. 6A through 6C illustrate example diagrams for multi-sample instructions for distribution of image processing workload between texture and shared processors in accordance with aspects of the present disclosure. In some examples, the examples illustrated in FIGS. 6A through 6C may implement aspects of the multimedia system 100. In some examples, aspects of the examples illustrated in FIGS. 6A through 6C may be implemented by a GPU of the devices 105.

FIG. 6A illustrates an example diagram showing samples stored at locations 605 in memory of the devices 105 according to a time sequence (e.g., sample 0, sample 1, . . . ) versus packed samples stored at locations 610 in memory of the devices 105 according to packed sampling (e.g., packed sample 0, packed sample 1, . . .) as described herein. The packed samples may be generated by the devices 105 according to example aspects of packed sampling as described herein. In some examples, the samples may be spread out or stored among locations which are not adjacent within the locations 605 (e.g., relatively far from one another). For example, the number of same or adjacent locations where the samples are stored may be sparse, for example, due to wave (e.g., 128 pixel) based issues. In some examples, the samples stored according to packed sampling may be stored among locations which are adjacent within the locations 605 (e.g., relatively near one another).

FIGS. 6B and 6C illustrate example diagrams showing improved cache locality based on accessing samples stored according to packed sampling in comparison to cache locality based on accessing samples stored according to the time sequence. For example, FIG. 6B illustrates samples 615 stored to memory of the devices 105 according to a time sequence. The location 625 may indicate positions in memory (e.g., cache memory) of the devices 105 where the sample 615-a (e.g., sample 1) may be stored. The location 630 may indicate positions in memory (e.g., cache) of the devices 105 where the sample 615-b (e.g., sample 0) may be stored. In other examples, FIG. 6C illustrates a packed sample 635 (e.g., packed sample 0) stored to memory of the devices 105 according to packed sampling. In an example, the devices 105 may have generated the packed sample 635 (e.g., packed sample 0) from sample 615-a (e.g., sample 1) and sample 615-b (e.g., sample 0). The location 645 may indicate locations in memory (e.g., cache) of the devices 105 where the packed sample 635 may be stored. The locations described herein may be locations of memory blocks in a cache memory of the devices 105.

The cache access occurrence 620 of FIG. 6B may indicate an example of what the device 105 may see when accessing the sample 615-a (e.g., sample 1). As illustrated in the example of FIG. 6B, samples which the device 105 may want to access (e.g., shaded samples) with respect to sample 615-a (e.g., sample 1) within locations 625 may be relatively far from samples which the device 105 may want to access (e.g., shaded samples) with respect to sample 615-b (e.g., sample 0) within locations 630, and thus cache access by the device 105 may be inefficient. The cache access occurrence 645 of FIG. 6C may indicate an example of what the devices 105 may view when accessing the packed sample 635 (e.g., packed sample 0). As illustrated in the example of FIG. 6C, samples which the devices 105 may access (e.g., shaded samples) with respect to the sample 615-a (e.g., sample 1) and sample 615-b (e.g., sample 0) as packed within the packed sample 635 (e.g., packed sample 0) may be adjacent or relatively near one another within locations 645, and thus cache access by the devices 105 may be much more efficient.

In view of the examples of aspects descried herein, the devices 105 may generate one or more instructions (e.g., macro instructions) to handle packed samples and weighted accumulation. For example, the devices 105 may use an instruction Dst=sam(src0.xy, s #,t #)*c0+sam(src0.zw, s #, t #)*c1 to generate a packed sample from multiple texel samples (e.g., two texel samples). The variables “xy” and “zq” may represent directionality associated with the samples “sam”, and “s #” and “t #” may respectively represent section numbers and texel values associated with the samples. In some examples, the devices 105 may reuse existing data paths and logics in storing and accessing data within the packed samples, limiting extra cost or overhead (e.g., memory access, increased processing power) and reducing power consumption by reduced general purpose register (GPR) access and improved cache locality (e.g., texel cache locality).

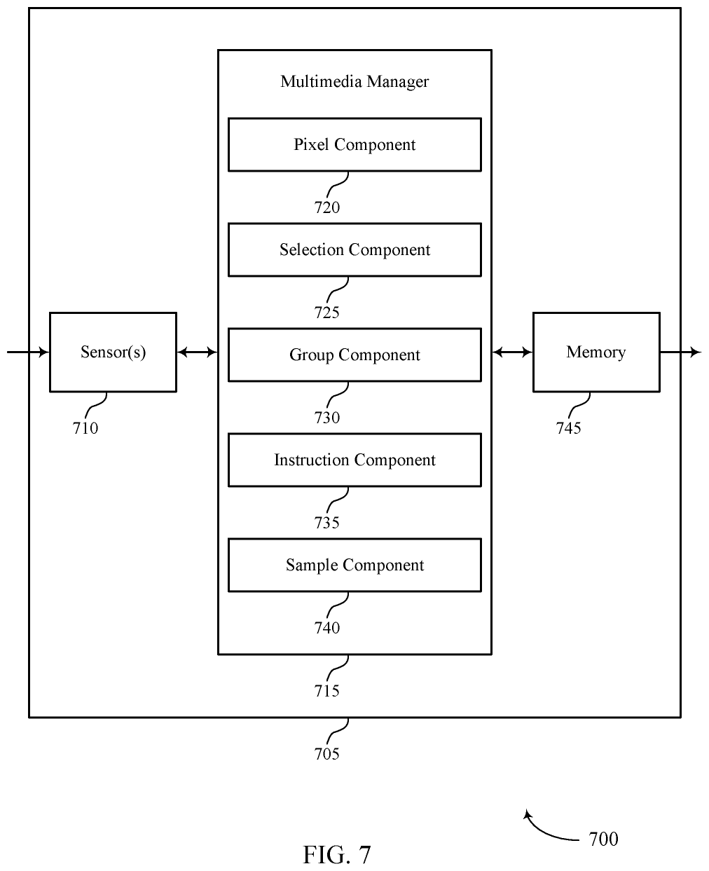

FIG. 7 shows a block diagram 700 of a device 705 that supports multi-sample instructions for distribution of image processing workload between texture and shared processors in accordance with aspects of the present disclosure. The device 705 may be an example of aspects of a device as described herein. The device 705 may include sensor(s) 710, an multimedia manager 715, and memory 745. The device 705 may also include a processor. Each of these components may be in communication with one another (e.g., via one or more buses).

The sensor(s) 710 may receive information such as packets, user data, or control information associated with various information channels (e.g., control channels, data channels, and information related to camera calibration, etc.). Information may be passed on to other components of the device 705. Sensor(s) 710 may be an example of an image sensor for capturing images. For example, sensor(s) 710 may represent a camera operable to capture an image of a scene that may be processed by the multimedia manager 715 alone according to aspects of the present disclosure. In another example, sensor(s) 710 may be an optical depth sensor (e.g., for determining or estimating a depth of an object or scene with respect to device 705), a lux sensor (e.g., for detecting an illumination condition, luminance levels), a motion sensor (e.g., for detecting motion associated with the scene), an infrared heat sensor (e.g., for detecting humans and animals vs. objects in the scene), among others. Sensor(s) 710 may, in some cases, be a charge coupled device (CCD) sensor or a complementary metal-oxide semiconductor (CMOS) sensor.

The multimedia manager 715, or its sub-components, may be implemented in hardware, code (e.g., software or firmware) executed by a processor, or any combination thereof. If implemented in code executed by a processor, the functions of the multimedia manager 715, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The multimedia manager 715, or its sub-components, may be physically located at various positions, including being distributed such that portions of functions are implemented at different physical locations by one or more physical components. In some examples, the multimedia manager 715, or its sub-components, may be a separate and distinct component in accordance with various aspects of the present disclosure. In some examples, the multimedia manager 715, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The multimedia manager 715 may include a pixel component 720, a selection component 725, a group component 730, an instruction component 735, and a sample component 740. The multimedia manager 715 may be an example of aspects of the multimedia manager 135 described herein. The pixel component 720 may identify a target pixel having a texel coordinate in an image. The selection component 725 may select, based on the texel coordinate, a first texel sample of a first set of texel samples and a second texel sample of a second set of texel samples. The group component 730 may group the first texel sample and the second texel sample into a third set of texel samples. The instruction component 735 may generate an instruction including the third set of texel samples and a weighted sum associated with the first texel sample and the second texel sample. The sample component 740 may process the third set of texel samples based on the instruction.

Memory 745 may include random access memory (RAM) and read only memory (ROM). The memory 550 may, additionally or alternatively, include static RANI (SRAM), dynamic RAM (DRAM), electrically erasable programmable read-only memory (EEPROM), compact disk-ROM (CD-ROM) or other optical disc storage, magnetic disc storage, or other magnetic storage devices, flash memory, or any other medium that can be used to store desired program code in the form of instructions or data structures and that can be accessed by a computer or a processor. Memory 745 may store computer-readable, computer-executable software including instructions that, when executed, cause the processor to perform various functions described herein. Memory 745 may store image data, configuration information (e.g., texel samples), among other information. In some cases, memory 745 may contain, among other things, a basic input/output system (BIOS) which may control basic hardware or software operation such as the interaction with peripheral components or devices

As detailed above, the multimedia manager 715 or one or more components of the multimedia manager 715 may perform or be a means for performing, either alone or in combination with other elements, one or more operations for camera calibration.

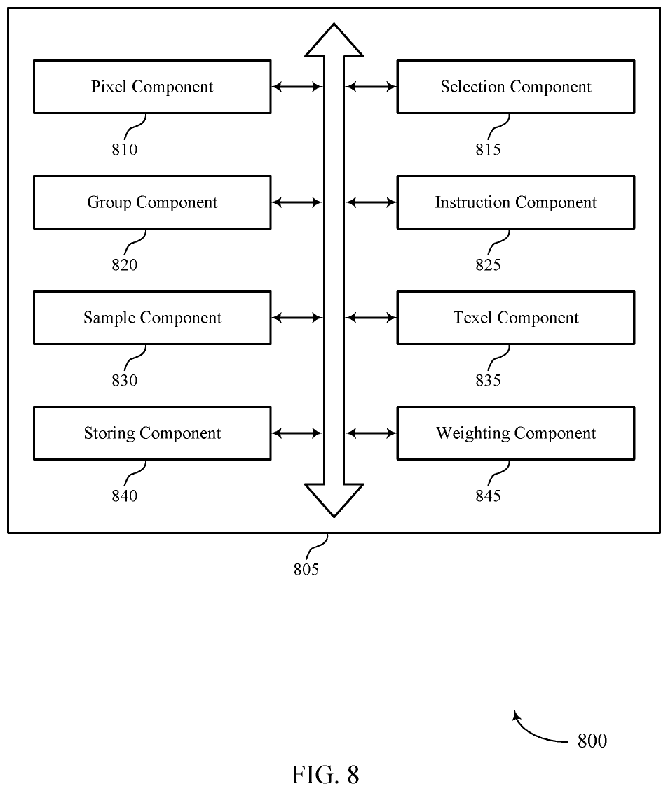

FIG. 8 shows a block diagram 800 of a multimedia manager 805 that supports multi-sample instructions for distribution of image processing workload between texture and shared processors in accordance with aspects of the present disclosure. The multimedia manager 805 may be an example of aspects of a multimedia manager 135, a multimedia manager 715, or a multimedia manager 910 described herein. The multimedia manager 805 may include a pixel component 810, a selection component 815, a group component 820, an instruction component 825, a sample component 830, a texel component 835, a storing component 840, and a weighting component 845. Each of these modules may communicate, directly or indirectly, with one another (e.g., via one or more buses).

The pixel component 810 may identify a target pixel having a texel coordinate in an image. The selection component 815 may select, based on the texel coordinate, a first texel sample of a first set of texel samples and a second texel sample of a second set of texel samples. The group component 820 may group the first texel sample and the second texel sample into a third set of texel samples. The instruction component 825 may generate an instruction including the third set of texel samples and a weighted sum associated with the first texel sample and the second texel sample. In some cases, the instruction includes a macro instruction. The sample component 830 may process the third set of texel samples based on the instruction. In some examples, the sample component 830 may process the first texel sample and the second texel sample in a single processing cycle.

The texel component 835 may determine a set of neighboring texels associated with the target pixel based on the texel coordinate, where selecting the first texel sample of the first set of texel samples and the second texel sample of the second set of texel samples is based on the set of neighboring texels. In some examples, the texel component 835 may select the first texel sample in a first direction with respect to the target pixel in the image. In some examples, the texel component 835 may select the second texel sample in a second direction with respect to the target pixel in the image. In some examples, the texel component 835 may select the first texel sample of the first set of texel samples and the second texel sample of the second set of texel samples is based on a distance between the texel coordinate of the target pixel and one or more of a texel coordinate of the first texel sample or a texel coordinate of the second texel sample. In some cases, one or more of the first texel sample or the second texel sample correspond to the set of neighboring texels. In some cases, the second direction is different from the first direction. In some cases, one or more of the first direction or the second direction includes a positive vertical direction with respect to the target pixel, a negative vertical direction with respect to the target pixel, a positive horizontal direction with respect to the target pixel, or a negative horizontal direction with respect to the target pixel.

The storing component 840 may store the third set of texel samples in a cache memory of the device based on the grouping. In some examples, the storing component 840 may store texel samples of the third set of texel samples in adjacent memory blocks in the cache memory. In some examples, the storing component 840 may store texel samples of the third set of texel samples in one or more memory blocks in the cache memory based on one or more previous memory paths. The weighting component 845 may determine a first weight associated with the first texel sample and a second weight with the second texel sample based on a distance between the texel coordinate of the target pixel and one or more of a texel coordinate of the first texel sample or a texel coordinate of the second texel sample. In some examples, the weighting component 845 may determine the weighted sum based on one or more of the first weight or the second weight.

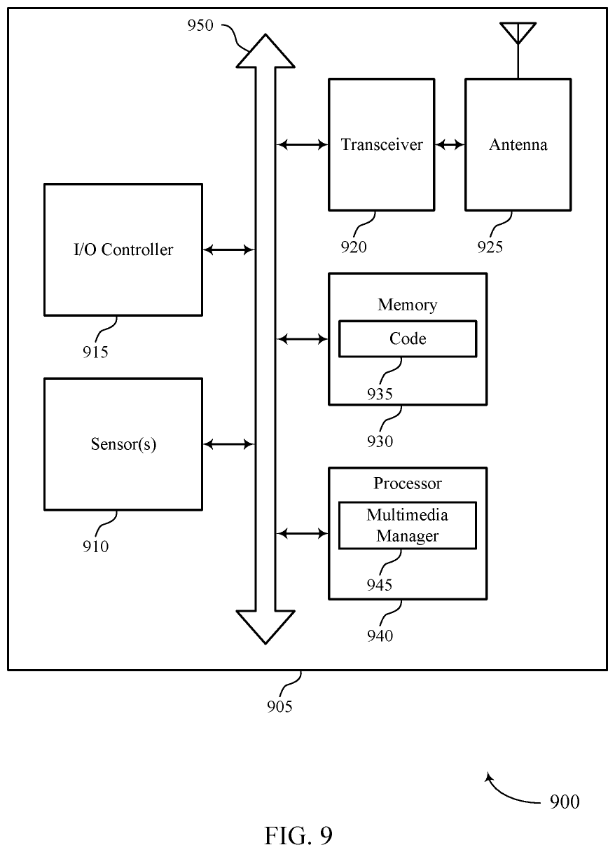

FIG. 9 shows a diagram of a system 900 including a device 905 that supports multi-sample instructions for distribution of image processing workload between texture and shared processors in accordance with aspects of the present disclosure. The device 905 may be an example of or include the components of device 705, or a device 105 as described herein. The device 905 may include components for bi-directional voice and data communications including components for transmitting and receiving communications, including sensor(s) 910, an I/O controller 915, a transceiver 920, an antenna 925, memory 930, and a processor 940. These components may be in electronic communication via one or more buses (e.g., bus 950).

The sensor(s) 910 may receive information such as packets, user data, or control information associated with various information channels (e.g., control channels, data channels, and information related to camera calibration, etc.). Information may be passed on to other components of the device 905. Sensor(s) 910 may be an example of an image sensor for capturing images. For example, sensor(s) 910 may represent a camera operable to capture an image of a scene alone according to aspects of the present disclosure. In another example, sensor(s) 910 may be an optical depth sensor (e.g., for determining or estimating a depth of an object or scene with respect to device 905), a lux sensor (e.g., for detecting an illumination condition, luminance levels), a motion sensor (e.g., for detecting motion associated with the scene), an infrared heat sensor (e.g., for detecting humans and animals vs. objects in the scene), among others. Sensor(s) 910 may, in some cases, be a charge coupled device (CCD) sensor or a complementary metal-oxide semiconductor (CMOS) sensor.

The I/O controller 915 may manage input and output signals for the device 905. The I/O controller 915 may also manage peripherals not integrated into the device 905. In some cases, the I/O controller 915 may represent a physical connection or port to an external peripheral. In some cases, the I/O controller 915 may utilize an operating system such as iOS, ANDROID, MS-DOS, MS-WINDOWS, OS/2, UNIX, LINUX, or another known operating system. In other cases, the I/O controller 915 may represent or interact with a modem, a keyboard, a mouse, a touchscreen, or a similar device. In some cases, the I/O controller 915 may be implemented as part of a processor. In some cases, a user may interact with the device 905 via the I/O controller 915 or via hardware components controlled by the I/O controller 915.

The transceiver 920 may communicate bi-directionally, via one or more antennas, wired, or wireless links as described herein. For example, the transceiver 920 may represent a wireless transceiver and may communicate bi-directionally with another wireless transceiver. The transceiver 920 may also include a modem to modulate the packets and provide the modulated packets to the antennas for transmission, and to demodulate packets received from the antennas. In some cases, the device 905 may include a single antenna 925. However, in some cases the device 905 may have more than one antenna 925, which may be capable of concurrently transmitting or receiving multiple wireless transmissions.

The memory 930 may include RAM and ROM. The memory 930 may store computer-readable, computer-executable code 935 including instructions that, when executed, cause the processor to perform various functions described herein. In some cases, the memory 930 may contain, among other things, a BIOS which may control basic hardware or software operation such as the interaction with peripheral components or devices.

The processor 940 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In other cases, a memory controller may be integrated into the processor 940. The processor 940 may be configured to execute computer-readable instructions stored in a memory (e.g., the memory 930) to cause the device 905 to perform various functions (e.g., functions or tasks supporting multi-sample instructions for distribution of image processing workload between texture and shared processors).

The processor 940 may include the multimedia manager 945, which may identify a target pixel having a texel coordinate in an image, select, based on the texel coordinate, a first texel sample of a first set of texel samples and a second texel sample of a second set of texel samples, group the first texel sample and the second texel sample into a third set of texel samples, generate an instruction including the third set of texel samples and a weighted sum associated with the first texel sample and the second texel sample, and process the third set of texel samples based on the instruction.

As detailed above, the multimedia manager 945 or one or more components of the multimedia manager 945 may perform or be a means for performing, either alone or in combination with other elements, one or more operations for camera calibration. For example, the multimedia manager 945 or one or more components of the multimedia manager 945 described herein may perform or be a means for identifying a target pixel having a texel coordinate in an image. The multimedia manager 945 or one or more components of the multimedia manager 945 described herein may perform or be a means for selecting, based at least in part on the texel coordinate, a first texel sample of a first set of texel samples and a second texel sample of a second set of texel samples. The multimedia manager 945 or one or more components of the multimedia manager 945 described herein may perform or be a means for grouping the first texel sample and the second texel sample into a third set of texel samples. The multimedia manager 945 or one or more components of the multimedia manager 945 described herein may perform or be a means for generating an instruction comprising the third set of texel samples and a weighted sum associated with the first texel sample and the second texel sample. The multimedia manager 945 or one or more components of the multimedia manager 945 described herein may perform or be a means for processing the third set of texel samples based at least in part on the instruction.

The code 935 may include instructions to implement aspects of the present disclosure, including instructions to support image processing. The code 935 may be stored in a non-transitory computer-readable medium such as system memory or other type of memory. In some cases, the code 935 may not be directly executable by the processor 940 but may cause a computer (e.g., when compiled and executed) to perform functions described herein.

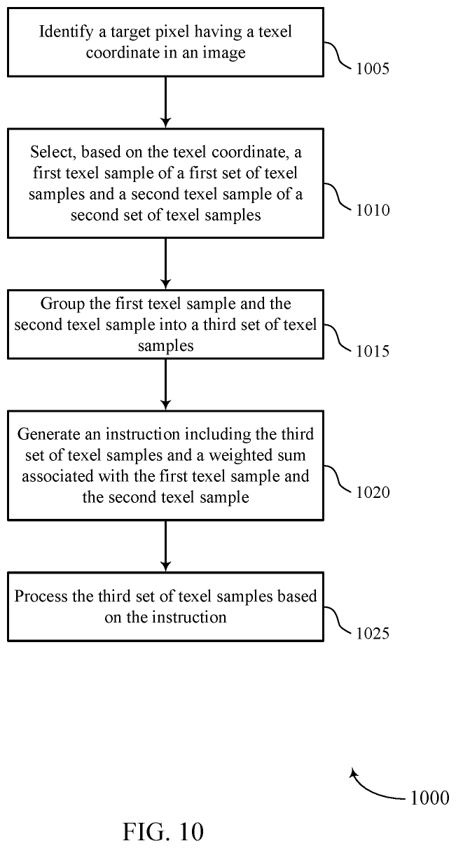

FIG. 10 shows a flowchart illustrating a method 1000 that supports multi-sample instructions for distribution of image processing workload between texture and shared processors in accordance with aspects of the present disclosure. The operations of method 1000 may be implemented by a device or its components as described herein. For example, the operations of method 1000 may be performed by a multimedia manager as described with reference to FIGS. 7 through 9. In some examples, a device may execute a set of instructions to control the functional elements of the device to perform the functions described herein. Additionally or alternatively, a device may perform aspects of the functions described herein using special-purpose hardware.

At 1005, the device may identify a target pixel having a texel coordinate in an image. The operations of 1005 may be performed according to the methods described herein. In some examples, aspects of the operations of 1005 may be performed by a pixel component as described with reference to FIGS. 7 through 9.

At 1010, the device may select, based on the texel coordinate, a first texel sample of a first set of texel samples and a second texel sample of a second set of texel samples. The operations of 1010 may be performed according to the methods described herein. In some examples, aspects of the operations of 1010 may be performed by a selection component as described with reference to FIGS. 7 through 9.

At 1015, the device may group the first texel sample and the second texel sample into a third set of texel samples. The operations of 1015 may be performed according to the methods described herein. In some examples, aspects of the operations of 1015 may be performed by a group component as described with reference to FIGS. 7 through 9.

At 1020, the device may generate an instruction including the third set of texel samples and a weighted sum associated with the first texel sample and the second texel sample. The operations of 1020 may be performed according to the methods described herein. In some examples, aspects of the operations of 1020 may be performed by an instruction component as described with reference to FIGS. 7 through 9.

At 1025, the device may process the third set of texel samples based on the instruction. The operations of 1025 may be performed according to the methods described herein. In some examples, aspects of the operations of 1025 may be performed by a sample component as described with reference to FIGS. 7 through 9.

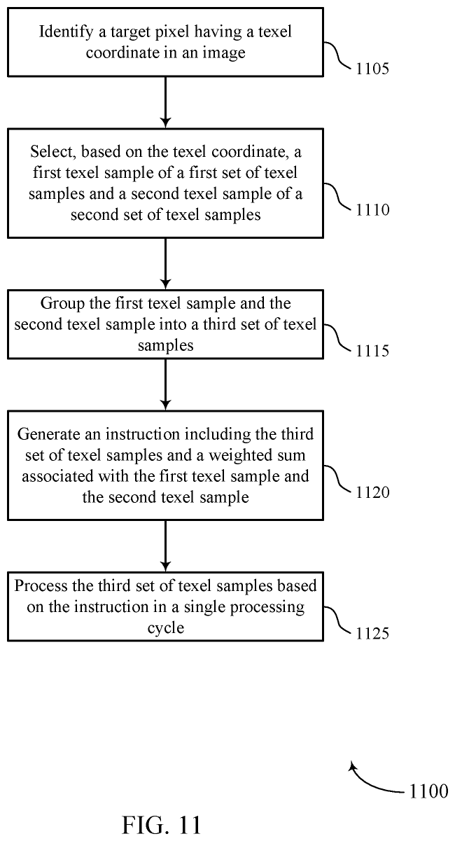

FIG. 11 shows a flowchart illustrating a method 1100 that supports multi-sample instructions for distribution of image processing workload between texture and shared processors in accordance with aspects of the present disclosure. The operations of method 1100 may be implemented by a device or its components as described herein. For example, the operations of method 1100 may be performed by a multimedia manager as described with reference to FIGS. 7 through 9. In some examples, a device may execute a set of instructions to control the functional elements of the device to perform the functions described herein. Additionally or alternatively, a device may perform aspects of the functions described herein using special-purpose hardware.

At 1105, the device may identify a target pixel having a texel coordinate in an image. The operations of 1105 may be performed according to the methods described herein. In some examples, aspects of the operations of 1105 may be performed by a pixel component as described with reference to FIGS. 7 through 9.

At 1110, the device may select, based on the texel coordinate, a first texel sample of a first set of texel samples and a second texel sample of a second set of texel samples. The operations of 1110 may be performed according to the methods described herein. In some examples, aspects of the operations of 1110 may be performed by a selection component as described with reference to FIGS. 7 through 9.

At 1115, the device may group the first texel sample and the second texel sample into a third set of texel samples. The operations of 1115 may be performed according to the methods described herein. In some examples, aspects of the operations of 1115 may be performed by a group component as described with reference to FIGS. 7 through 9.

At 1120, the device may generate an instruction including the third set of texel samples and a weighted sum associated with the first texel sample and the second texel sample. The operations of 1120 may be performed according to the methods described herein. In some examples, aspects of the operations of 1120 may be performed by an instruction component as described with reference to FIGS. 7 through 9.

At 1125, the device may process the third set of texel samples based on the instruction in a single processing cycle. The operations of 1125 may be performed according to the methods described herein. In some examples, aspects of the operations of 1125 may be performed by a sample component as described with reference to FIGS. 7 through 9.

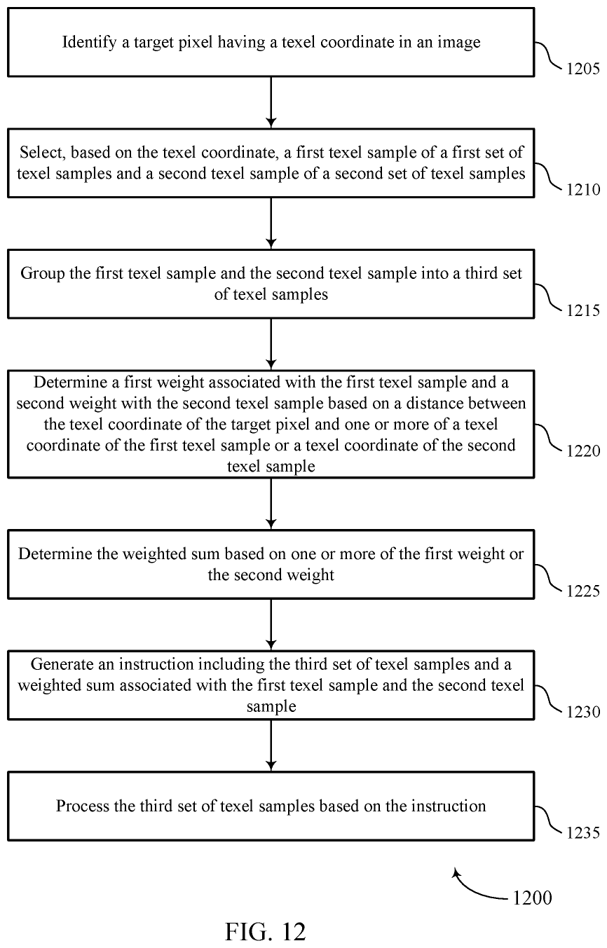

FIG. 12 shows a flowchart illustrating a method 1200 that supports multi-sample instructions for distribution of image processing workload between texture and shared processors in accordance with aspects of the present disclosure. The operations of method 1200 may be implemented by a device or its components as described herein. For example, the operations of method 1200 may be performed by a multimedia manager as described with reference to FIGS. 7 through 9. In some examples, a device may execute a set of instructions to control the functional elements of the device to perform the functions described herein. Additionally or alternatively, a device may perform aspects of the functions described herein using special-purpose hardware.

At 1205, the device may identify a target pixel having a texel coordinate in an image. The operations of 1205 may be performed according to the methods described herein. In some examples, aspects of the operations of 1205 may be performed by a pixel component as described with reference to FIGS. 7 through 9.

At 1210, the device may select, based on the texel coordinate, a first texel sample of a first set of texel samples and a second texel sample of a second set of texel samples. The operations of 1210 may be performed according to the methods described herein. In some examples, aspects of the operations of 1210 may be performed by a selection component as described with reference to FIGS. 7 through 9.

At 1215, the device may group the first texel sample and the second texel sample into a third set of texel samples. The operations of 1215 may be performed according to the methods described herein. In some examples, aspects of the operations of 1215 may be performed by a group component as described with reference to FIGS. 7 through 9.

At 1220, the device may determine a first weight associated with the first texel sample and a second weight with the second texel sample based on a distance between the texel coordinate of the target pixel and one or more of a texel coordinate of the first texel sample or a texel coordinate of the second texel sample. The operations of 1220 may be performed according to the methods described herein. In some examples, aspects of the operations of 1220 may be performed by a weighting component as described with reference to FIGS. 7 through 9.

At 1225, the device may determine the weighted sum based on one or more of the first weight or the second weight. The operations of 1225 may be performed according to the methods described herein. In some examples, aspects of the operations of 1225 may be performed by a weighting component as described with reference to FIGS. 7 through 9.

At 1230, the device may generate an instruction including the third set of texel samples and a weighted sum associated with the first texel sample and the second texel sample. The operations of 1230 may be performed according to the methods described herein. In some examples, aspects of the operations of 1230 may be performed by an instruction component as described with reference to FIGS. 7 through 9.

At 1235, the device may process the third set of texel samples based on the instruction. The operations of 1235 may be performed according to the methods described herein. In some examples, aspects of the operations of 1235 may be performed by a sample component as described with reference to FIGS. 7 through 9.

It should be noted that the methods described herein describe possible implementations, and that the operations and the steps may be rearranged or otherwise modified and that other implementations are possible. Further, aspects from two or more of the methods may be combined.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for image processing at a device, comprising:
identifying a target pixel having a texel coordinate in an image;
selecting, based at least in part on the texel coordinate, a first texel sample of a first set of texel samples and a second texel sample of a second set of texel samples;
grouping the first texel sample and the second texel sample into a third set of texel samples;
generating an instruction comprising the third set of texel samples and a weighted sum associated with the first texel sample and the second texel sample; and
processing the third set of texel samples based at least in part on the instruction.

2. The method of claim 1, further comprising:
determining a set of neighboring texels associated with the target pixel based at least in part on the texel coordinate,
wherein selecting the first texel sample of the first set of texel samples and the second texel sample of the second set of texel samples is based at least in part on the set of neighboring texels.

3. The method of claim 2, wherein one or more of the first texel sample or the second texel sample correspond to the set of neighboring texels.

4. The method of claim 1, wherein selecting the first texel sample of the first set of texel samples and the second texel sample of the second set of texel samples comprises:
selecting the first texel sample in a first direction with respect to the target pixel in the image; and
selecting the second texel sample in a second direction with respect to the target pixel in the image.

5. The method of claim 4, wherein the second direction is different from the first direction.

6. The method of claim 4, wherein one or more of the first direction or the second direction comprises a positive vertical direction with respect to the target pixel, a negative vertical direction with respect to the target pixel, a positive horizontal direction with respect to the target pixel, or a negative horizontal direction with respect to the target pixel.

7. The method of claim 1, wherein selecting the first texel sample of the first set of texel samples and the second texel sample of the second set of texel samples is based at least in part on a distance between the texel coordinate of the target pixel and one or more of a texel coordinate of the first texel sample or a texel coordinate of the second texel sample.

8. The method of claim 1, further comprising:
storing the third set of texel samples in a cache memory of the device based at least in part on the grouping.

9. The method of claim 8, wherein storing the third set of texel samples in the cache memory comprises:
storing texel samples of the third set of texel samples in adjacent memory blocks in the cache memory.

10. The method of claim 8, wherein storing the third set of texel samples in the cache memory comprises:
storing texel samples of the third set of texel samples in one or more memory blocks in the cache memory based at least in part on one or more previous memory paths.

11. The method of claim 1, wherein processing the third set of texel samples comprises:
processing the first texel sample and the second texel sample in a single processing cycle.

12. The method of claim 1, wherein the instruction comprises a macro instruction.

13. The method of claim 1, further comprising:
determining a first weight associated with the first texel sample and a second weight with the second texel sample based at least in part on a distance between the texel coordinate of the target pixel and one or more of a texel coordinate of the first texel sample or a texel coordinate of the second texel sample; and
determining the weighted sum based at least in part on one or more of the first weight or the second weight.

14. An apparatus for image processing, comprising:
a processor,
memory coupled with the processor; and
instructions stored in the memory and executable by the processor to cause the apparatus to:
identify a target pixel having a texel coordinate in an image;
select, based at least in part on the texel coordinate, a first texel sample of a first set of texel samples and a second texel sample of a second set of texel samples;
group the first texel sample and the second texel sample into a third set of texel samples;
generate an instruction comprising the third set of texel samples and a weighted sum associated with the first texel sample and the second texel sample; and
process the third set of texel samples based at least in part on the instruction.

15. The apparatus of claim 14, wherein the instructions are further executable by the processor to cause the apparatus to:
determine a set of neighboring texels associated with the target pixel based at least in part on the texel coordinate,
wherein the instructions to select the first texel sample of the first set of texel samples and the second texel sample of the second set of texel samples are further executable by the processor based at least in part on the set of neighboring texels.

16. The apparatus of claim 15, wherein one or more of the first texel sample or the second texel sample correspond to the set of neighboring texels.

17. The apparatus of claim 14, wherein the instructions to select the first texel sample of the first set of texel samples and the second texel sample of the second set of texel samples are executable by the processor to cause the apparatus to:
select the first texel sample in a first direction with respect to the target pixel in the image; and
select the second texel sample in a second direction with respect to the target pixel in the image.

18. The apparatus of claim 17, wherein the second direction is different from the first direction.

19. The apparatus of claim 17, wherein one or more of the first direction or the second direction comprises a positive vertical direction with respect to the target pixel, a negative vertical direction with respect to the target pixel, a positive horizontal direction with respect to the target pixel, or a negative horizontal direction with respect to the target pixel.

20. An apparatus for image processing, comprising:
means for identifying a target pixel having a texel coordinate in an image;
means for selecting, based at least in part on the texel coordinate, a first texel sample of a first set of texel samples and a second texel sample of a second set of texel samples;
means for grouping the first texel sample and the second texel sample into a third set of texel samples;
means for generating an instruction comprising the third set of texel samples and a weighted sum associated with the first texel sample and the second texel sample; and
means for processing the third set of texel samples based at least in part on the instruction.
